(19) United States
(12) Patent Application Publication
(10) Pub. No.: US 2005/0091641 A1
(43) Pub. Date: Apr. 28, 2005

(54) System and method for modifying a host user interface

(76) Inventors: Bryan Thomas Starbuck, Redmond, WA (US); Gail Borod Giacobbe, Seattle, WA (US); Manoj K. Jain, Hyderabad (IN); Archan Das, Hyderabad (IN); John Lueders, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/692,280

(22) Filed: Oct. 23, 2003

(51) Int. Cl. G06F 9/44; G06F 17/30

(52) U.S. Cl. 717/122; 717/170; 707/203; 707/101

(57) ABSTRACT

A method, system, and computer-accessible medium are provided for safely modifying a host user interface with one or more extension user interfaces. The system comprises command item and insert location data structures, and host and extension programming interfaces. The programming interfaces facilitate negotiating modifications to a host user interface (UI) with extension commands specified by the extension in the command item data structure at locations specified by the host in the insert location data structure. The command item and insert locations are uniquely identified with unique universal identifiers (UUID) that enable the host to control the modification of the host UI by multiple extensions. The command item data structure contains the command's UI. The host modifies the host UI to insert the extension's commands in accordance with the command's UI.

### FIELD OF THE INVENTION

In general, the present invention relates to computer software and user interfaces and, in particular, to systems and methods for controlling modifications to a user interface.

### BACKGROUND OF THE INVENTION

In general, software applications and the operating systems in which they run provide user interfaces (UIs) to the commands necessary to use the functions of the application or system. The commands are typically represented in the UI as selectable items with text or as a combination of text and an image (e.g., a command icon), and are organized into lists that facilitate the selection and execution of the commands. The lists of selectable items are often hierarchical, with sub-lists of items nested within the lists of items. Examples of different types of common UIs that manage lists of items representing commands are the familiar menu and submenu, often seen in today's applications, toolbars, often with drop-down lists, as well as lists of hyperlinks, buttons, and tasks.

The UIs provided by an application or operating system are frequently modified by other applications to customize, add to, or otherwise enhance the functionality of the original application or operating system and/or the appearance of the UI. In this context, the original application or operating system is generally referred to as the host, and the other applications are generally referred to as extensions to the host, so named because they are used to extend various aspects of the host. Extensions take a variety of forms, including plug-ins, add-ins, utilities, or any other type of executable software. Hosts whose usefulness can be extended in this way include graphical operating systems, like the Microsoft Windows® operating system, and applications having a graphical user interface such as the Microsoft Outlook® e-mail client or Internet Explorer® browser products.

The Windows® operating system provides various programming interfaces that extensions can use to facilitate modifying a host UI after the host UI has been loaded or created. For menu-type UIs, these changes may include adding or removing menu items and modifying existing menu items by the menu item's identifier or by the menu item's position.

The menu item's identifier is a unique, host-assigned integer associated with each menu item. The menu item's position is a zero-based integer that indicates where the menu item is located relative to the other menu items in the host menu, including the separators, the non-selectable horizontal lines that are used to divide a vertical menu into groups of related items. For example, the leftmost item in a horizontal menu (or the topmost item in a vertical menu) would likely be assigned a menu item identifier of “1” located at position “0.”

An example of one such Windows® programming interface to facilitate changing a host menu is IContextMenu, an interface to the Windows® context menu (the shortcut menu that is provided when a user right clicks on certain objects accessed via the Windows® Shell). For instance, using the QueryContextMenu method of the IContextMenu interface and the InsertMenuItem function, an extension may add a new menu item to the context menu. With this interface, the host returns the minimum and maximum values that the extension can use to assign menu-item identifiers when inserting new menu items, and the extension specifies the zero-based position at which to insert the new menu item.

As the use of extensions to enhance the functionality of hosts becomes more prevalent, it is not uncommon for a host UI to be modified by several extensions at the same time. A host cannot realistically know of all the extensions that exist. This can lead to conflicts in the UI, particularly when multiple extensions are modifying the same positions within the host's original UI. Sometimes the conflicts render the UI unusable due to accidental deletion or modification of critical commands from the UI. Some extensions can even render the original application or operating system unstable, causing it to hang. In some cases, malicious extensions spam the host UI with modifications to intentionally cause the host to hang. Existing programming interfaces, such as IContextMenu, fail to prevent such problems.

Moreover, many subjective decisions go into laying out a UI. Considerations of aesthetics, simplicity, the goal of the underlying host software, and the target user, among others, all factor into the UI layout. The goals and target user will often change between versions of the host software, resulting in changes in the UI layout from one version to the next. An extension UI is generally designed to match the host's UI layout in the version(s) of the host software that exists during the extension development. Thus, when extensions attempt to extend versions of the host UI later than the version for which they were originally designed, they are often incompatible. An example scenario is a host application that removes its “View” submenu and merges those submenu items into one or more other submenus, such as the “Tools” submenu. Extensions that attempt to add commands to the “View” submenu using existing programming interfaces may fail. Neither can the host realistically test every extension when developing the new version of the host UI to avoid such failures.

### SUMMARY OF THE INVENTION

To overcome the above-described problems, a system, method, and computer-accessible medium for modifying a host UI are provided. The system and method provide an improved programming interface that permits multiple extensions to safely modify the host's UI, regardless of the version of the host UI for which they were originally designed.

In accordance with one aspect of the present invention, each command represented in the host UI is associated with a command item. A command item is an object that is uniquely identified by a universal unique identifier (UUID) and has a number of properties that define the UI for the associated command. For example, a command item may include properties that define the display icon, text, and hotkeys for the associated command, as well as properties that define some of the off-screen features provided for the command, including the tooltip description, the help topic text, etc.

In accordance with another aspect of the present invention, a host constrains extensions by permitting new commands to be inserted in the host UI only at certain insert locations. An insert location represents an actual location in the host UI where the inserted command's extension UI will be displayed. Like a command item, an insert location is also uniquely identified by a UUID. The actual location of an insert location in a host UI is dynamically defined by the host, and may change or even be eliminated from one version of the host UI to another.

In accordance with a further aspect of the present invention, using the improved programming interface, the host passes the available insert locations to extensions that seek to modify the UI. Each extension returns one or a set of command items that represent the commands that the extension requests to add to the host's UI at one or more of the available insert locations. The host loads the extensions and recursively modifies the UI as requested by each extension in accordance with the available insert locations and the extension's load order relative to the other extensions. The load order may be arbitrary or predefined.

In accordance with yet another aspect of the present invention, before returning the command items that represent the commands that the extension requests to add to the host's UI, each extension may itself load subextensions that recursively modify the extension's UI similar to the manner in which the host loads extensions that modify the host's UI. In this way, the improved interface not only prevents UI conflicts between competing extensions, but also prevents interference with a parent extension's modifications of its own UI.

In accordance with a still further aspect of the present invention, after loading the extensions, the commands are displayed in the modified host UI at the designated insert locations using the properties defined in the associated command item.

In accordance with yet other aspects of the present invention, a computer accessible medium for modifying a host UI is provided. The computer accessible medium comprises data structures and computer executable components comprising a programming interface for permitting multiple extensions to safely modify the host's UI, regardless of the version of the host UI for which they were originally designed. The data structures define command item and insert location data in a manner that is generally consistent with the above-described method. Likewise, the computer executable components are capable of performing actions generally consistent with the above-described method.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a depiction of an exemplary menu and submenu type UI that is capable of modification in accordance with the present invention;

FIG. 2 is a depiction of an exemplary toolbar type UI with a pull-down menu that is capable of modification in accordance with the present invention;

FIG. 3 is a block diagram of a general purpose computer system suitable for containing a host UI that may be modified in accordance with the present invention;

FIG. 4 is a block diagram of a user interface resource formed in accordance with the present invention;

FIG. 5 is a block diagram of a programming interface between a host and an extension formed in accordance with the present invention;

FIG. 6 is a pictorial diagram of an exemplary host UI employing a version of the present invention;

FIG. 7 is a pictorial diagram of a portion of the exemplary host UI of FIG. 6 shown in relation to multiple extensions and command items;

FIG. 8 is a pictorial diagram of the portion of the exemplary host UI of FIG. 6 modified with multiple extensions and command items of FIG. 7;

FIG. 9 is a pictorial diagram of a first version of an exemplary modified host UIemploying a version of the present invention;

FIG. 10 is a pictorial diagram of a second version of an exemplary modified host UI employing a version of the present invention; and

FIG. 11 is a flow diagram illustrating the logic performed by a general purpose computer system for modifying a host UI formed in accordance with the present invention.

### DETAILED DESCRIPTION OF THE PREFERRED EMBODIMENT

The following discussion is intended to provide a brief, general description of a computing system suitable for implementing various features of the invention. While the computing system will be described in the general context of a personal computer usable in a distributed computing environment, where complementary tasks are performed by remote computing devices linked together through a communication network, those skilled in the art will appreciate that the invention may be practiced with many other computer system configurations, including multiprocessor systems, minicomputers, mainframe computers, and the like. In addition to the more conventional computer systems described above, those skilled in the art will recognize that the invention may be practiced on other computing devices including laptop computers, tablet computers, personal digital assistants (PDAs), and other devices upon which computer software or other digital content is installed.

While aspects of the invention may be described in terms of programs executed by a Web browser in conjunction with a personal computer, those skilled in the art will recognize that those aspects also may be implemented in combination with other program modules. Generally, program modules include routines, programs, components, data structures, etc., that perform particular tasks or implement particular abstract data types.

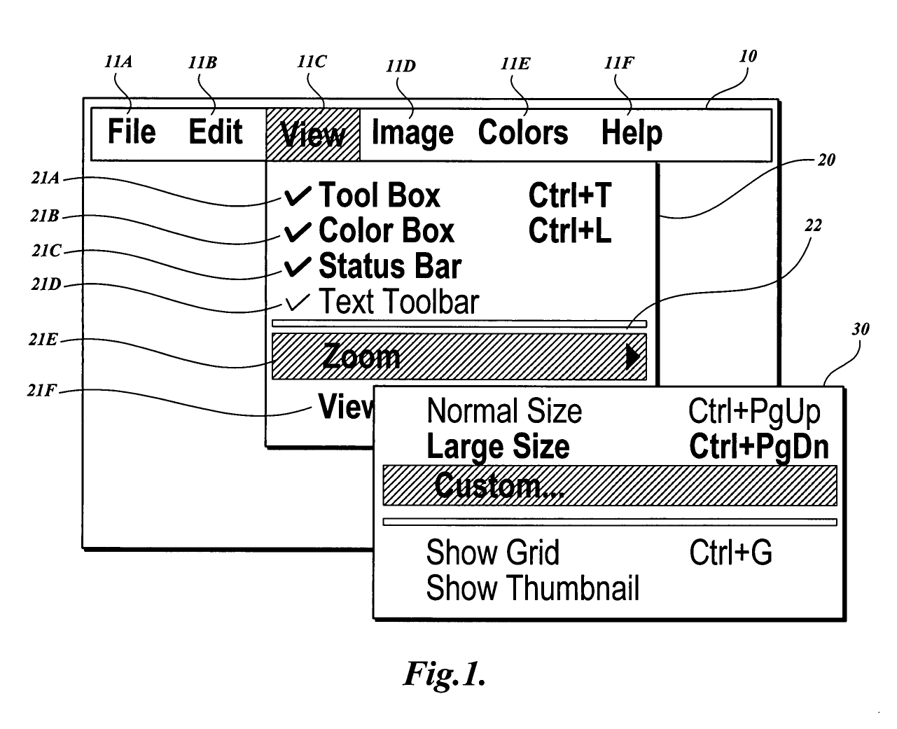

FIG. 1 illustrates a typical menu and submenu UI that is hierarchically organized into a horizontal menu bar 10 that has six menu items 11, including File 11A, Edit 11B, View 11C, Image 11D, Colors 11E, and Help 11F. Selecting any of the six menu items 11 will display the next level of the menu hierarchy in a vertical submenu list, such as the View submenu list 20. As shown, the View submenu list 20 has six submenu items 21, including Tool Box 21A, Color Box 21B, Status Bar 21C, Text Toolbar 21D, Zoom 21E, and View Bitmap 21F. The first four submenu items are separated from the last two items with a menu separator 22. A menu separator 22 is a nonselectable horizontal line that is used to divide a menu into groups of related items. Selecting one of the submenu items 21 will either execute a command associated with that submenu item (e.g., “View Bitmap”) or will open up a next level of the menu hierarchy in another vertical submenu list (or other type of UI) that will typically provide the user with more submenu selections or prompt the user for more information to complete the selection already made. For example, in the illustrated submenu 20, selecting the submenu item Zoom 21E opens up another submenu 30 listing selectable options for different image sizes available for display with the Zoom command.

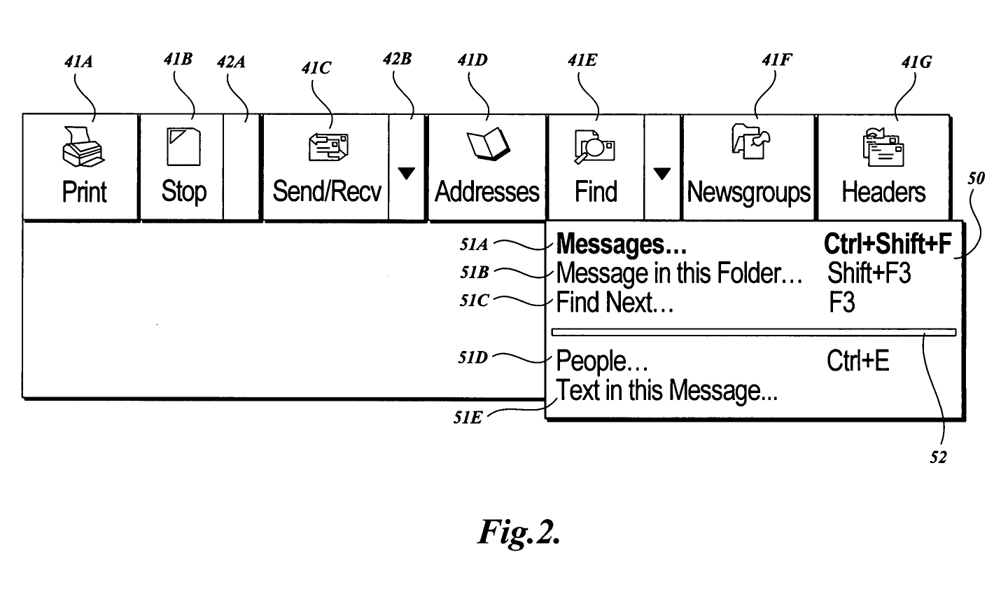

FIG. 2 illustrates a typical toolbar and pull-down list UI that is hierarchically organized into a horizontal tool bar 400 that has seven menu items 41, including Print 41A, Stop 41B, Send/Recv 41C, Addresses 41D, Find 41E, Newsgroups 41F, and Headers 41G. The third toolbar item is separated from the items on either side of it with a tool separator 42A and 42B. A tool separator 42 is a nonselectable vertical line that is used to divide a toolbar into groups of related items. Selecting any of the seven tool items 41 will execute the associated command (e.g., “Print”) or will open up a next level of the toolbar hierarchy in a vertical pull-down list (or other type of UI), such as the Find pull-down list 50 that will typically provide the user with submenu selections or prompt the user for more information to complete the selection already made. As shown, the Find pull-down list 50 has five submenu items 51, including Message 51A, Message in this Folder 51B, Find Next 51C, People 51D, and Text in this Message 51E. The third and fourth pull-down items are separated from one another with a pull-down list separator 52. Like a submenu separator 22, a pull-down list separator 52 is a nonselectable horizontal line that is used to divide a toolbar into groups of related items.

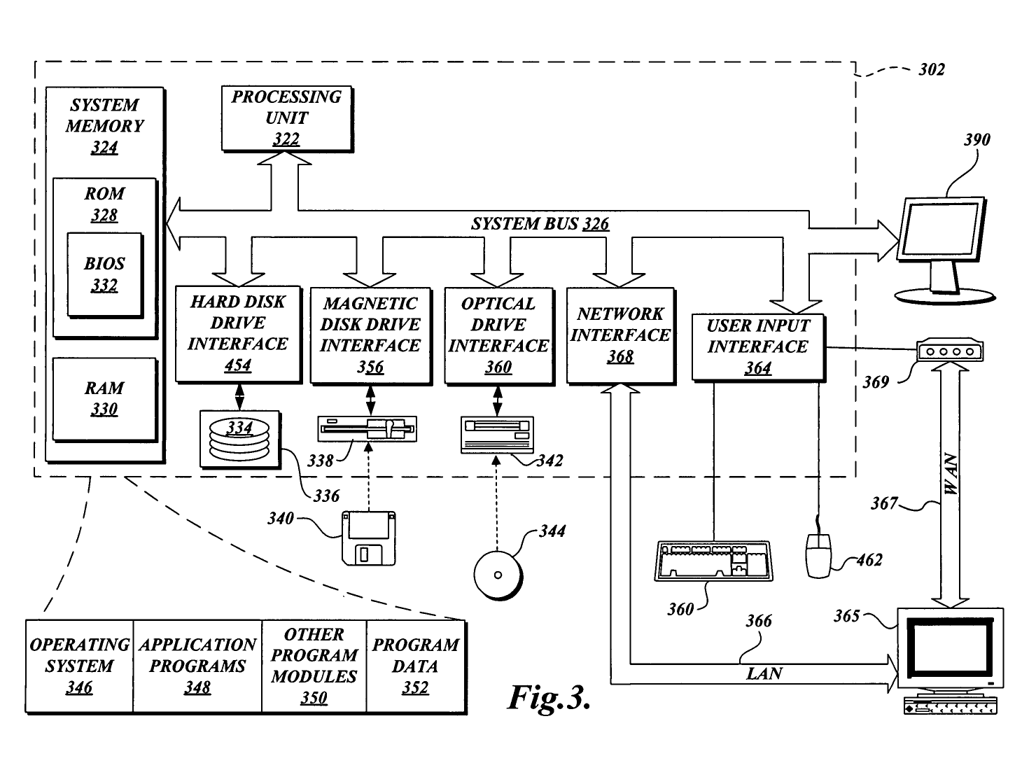

FIG. 3 is a block diagram of a general purpose computer system 300 suitable for containing a host UI that may be modified in accordance with the present invention. The system 300 includes a personal computer 302 comprising a processing unit 322, a system memory 324, and a system bus 326 that couples the system memory to the processing unit 322. The system memory 324 includes read-only memory (ROM) 328 and random-access memory (RAM) 330. A basic input/output system 332 (BIOS), containing the basic routines that help to transfer information between elements within the personal computer 302, such as during startup, is stored in ROM 328. The personal computer 302 further includes a hard disk drive 334, a magnetic disk drive 338, e.g., to read from or write to a removable disk 340, and an optical disk drive 342, e.g., for reading a CD-ROM disk 344 or to read from or write to other optical media. The hard disk drive 334, magnetic disk drive 338, and optical disk drive 342 are connected to the system bus 326 by a hard disk drive interface 354, a magnetic disk drive interface 356, and an optical drive interface 360, respectively. The drives and their associated computer-readable media provide nonvolatile storage for the personal computer 302. Although the description of computer-readable media above refers to a hard disk, a removable magnetic disk, and a CD-ROM disk, it should be appreciated by those skilled in the art that other types of media that are readable by a computer, such as magnetic cassettes, flash memory cards, digital video disks, Bernoulli cartridges, ZIP disks, and the like may also be used in the exemplary operating environment.

A number of program modules may be stored in the drives and RAM 330, including an operating system 346, one or more application programs 348, other program modules 350 such as the extensions and interfaces of the present invention, and program data 352, including the command item and insert location data of the present invention. A user may enter commands and information into the personal computer 302 through input devices such as a keyboard 360 or a mouse 362. Other input devices (not shown) may include a microphone, touch pad, joystick, game pad, satellite dish, scanner, or the like. These and other input devices are often connected to the processing unit 322 through a user input interface 364 that is coupled to the system bus, but may be connected by other interfaces (not shown), such as a game port or a universal serial bus (USB). A display device 390 is also connected to the system bus 326 via a display subsystem that typically includes a graphics display interface (not shown) and a code module, sometimes referred to as a display driver, to interface with the graphics display interface. While illustrated as a stand-alone device, the display device 390 could be integrated into the housing of the personal computer 302. Furthermore, in other computing systems suitable for implementing the invention, such as a PDA, the display could be overlaid with a touch-screen. In addition to the elements illustrated in FIG. 3, client devices also typically include other peripheral output devices (not shown), such as speakers or printers.

The personal computer 302 may operate in a networked environment using logical connections to one or more remote computers, such as a remote computer 365. The remote computer 365 may be a server, a router, a peer device, or other common network node, and typically includes many or all of the elements described relative to the personal computer 302. The logical connections depicted in FIG. 3 include a local area network (LAN) 366 and a wide area network (WAN) 367. The LAN 366 and WAN 367 may be wired, wireless, or a combination thereof. Such networking environments are commonplace in offices, enterprise-wide computer networks, Intranets, and the Internet.

When used in a LAN networking environment, the personal computer 302 is connected to the LAN 366 through a network interface 368. When used in a WAN networking environment, the personal computer 302 typically includes a modem 369 or other means for establishing communications over the WAN 367, such as the Internet. The modem 369, which may be internal or external, is connected to the system bus 326 via the user input interface 364. In a networked environment, program modules depicted relative to the personal computer 302, or portions thereof, may be stored in the remote memory storage device. It will be appreciated that the network connections shown are exemplary and other means of establishing a communication link between the computers may be used. In addition, the LAN 366 and WAN 367 may be used as a source of nonvolatile storage for the system.

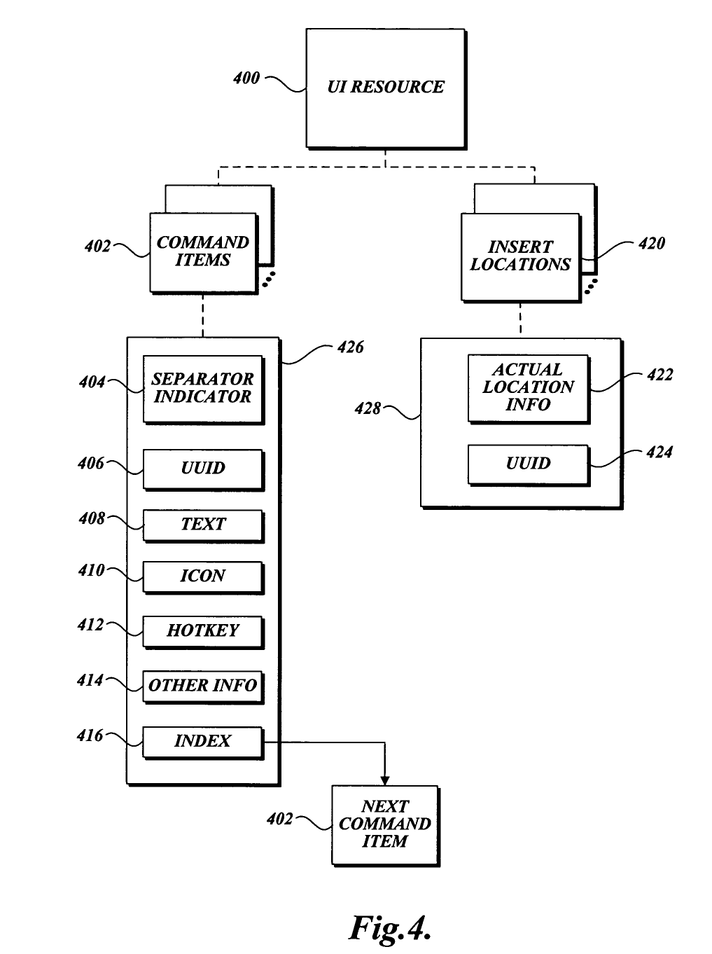

FIG. 4 is a block diagram of an exemplary UI resource. A host that permits its UI to be modified in accordance with the present invention lays out the various UI components (e.g., command items, insert locations, separators, etc.) in a UI resource 400. An extension that has sub-extensions that can modify its UI lays out the UI in a declarative list that is analogous to the UI resource 400. Thus, for convenience the following description of a resource 400 will refer to the host but may apply both to hosts and extensions. The collection of UI components in a resource 400 permits the UI to be easily localized or changed later. Each of the commands in the host UI is represented by a command item 402 in the resource 400. A command item 402 is a collection of data about a command that may be stored in a data structure 426. For each of the command items the host generates, a UUID 406.

The host identifies the actual locations 422 in the host UI where the host will allow one or more new command items 402 to be inserted by an extensions (or, in the case of a resource 400 for an extension UI, to be inserted by a sub-extension). More specifically, each of the actual locations 422 is represented by an insert location 420 in the resource 400. An insert location 420 is a collection of data about a location that may be stored in a data structure 428. For each of the insert locations, the host also generates a UUID 424.

The host is able to track various properties for each command item 402, including the text 408 that is to be displayed in the UI for the command, the icon 410 that is to be used to depict the command, the hotkey 412 associated with the command, and any other information 414 associated with the command, such as tip information displayed with the user, hovers a pointing device over the text 408 or icon 410 representing the command, or the help text that is displayed when a user requests help with the command.

The command item 402 may include an index 416 for use when multiple command items 420 are specified in an array. Command items 402 are specified in an array when there are sibling command items or child command items. For example, sibling command items occur when there are related commands that appear next to one another in a menu or submenu, and child command items occur when there are submenu items that are revealed when a user clicks on a parent command that has one or more children commands, e.g., a submenu within a menu, or a pull-down list within a toolbar.

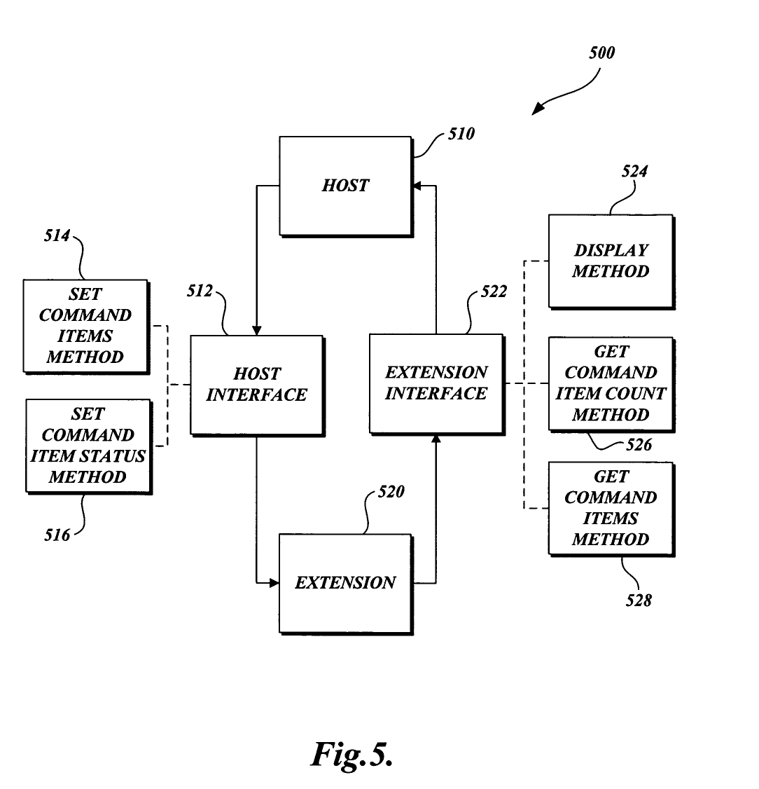

FIG. 5 is a block diagram of an exemplary programming interface 500 between a host and an extension in accordance with the present invention. FIG. 5 includes a host 510 that implements a host interface 512 that permits the host UI to be extended. The host interface 512 provides the extensions with two methods that facilitate the insertion of new commands into the host UI. Other methods may also be included. The two illustrated methods include a set command items method 514 that is used by the extensions to specify which command items 402 to insert by command item UUID 406, and what insert location 420 to use by insert location UUID 424. The other illustrated method is a set command item status method 516 that is used by the extension to update the status of a command item (e.g., whether it should be enabled or disabled, checked or unchecked, selected or not, etc.).

FIG. 5 also includes an extension 520 that implements an extension interface 522 to integrate the extension's UI with the host UI. The extension interface 522 provides the host with three methods that facilitate the insertion of new commands into the host UI. Other methods may also be included. The three illustrated methods include a display method 524 that is called by the host 510 when each menu item in a host UI is being displayed. In response, the extension uses the set command items method 514 to update the contents of the insert location 420 associated with the displayed menu item. The second illustrated method is a get command item count method 526 that returns to the host 510 the number of command items to be inserted at a specified insert location, including the number of child or sibling command items. The third illustrated method is a get command items method 528 that returns to the host 510 the command items 402 to be inserted at a specified insert location 420.

Preferably, the extension interface 522 extends an existing programming interface for commands, such as the IOleCommandTarget interface. For example, the host may call the Exec method of the IOleCommandTarget interface to execute a command when a user has selected a command item in the extended host UI. The host may further use the QueryStatus method of the IOleCOmmandTarget interface to determine the UI state of a command item 402 in preparation for displaying the command item's UI (corresponding to the above-described set command item status method 516, as implemented by the host 510 and used by an extension 530 to update the status of a command item 402).

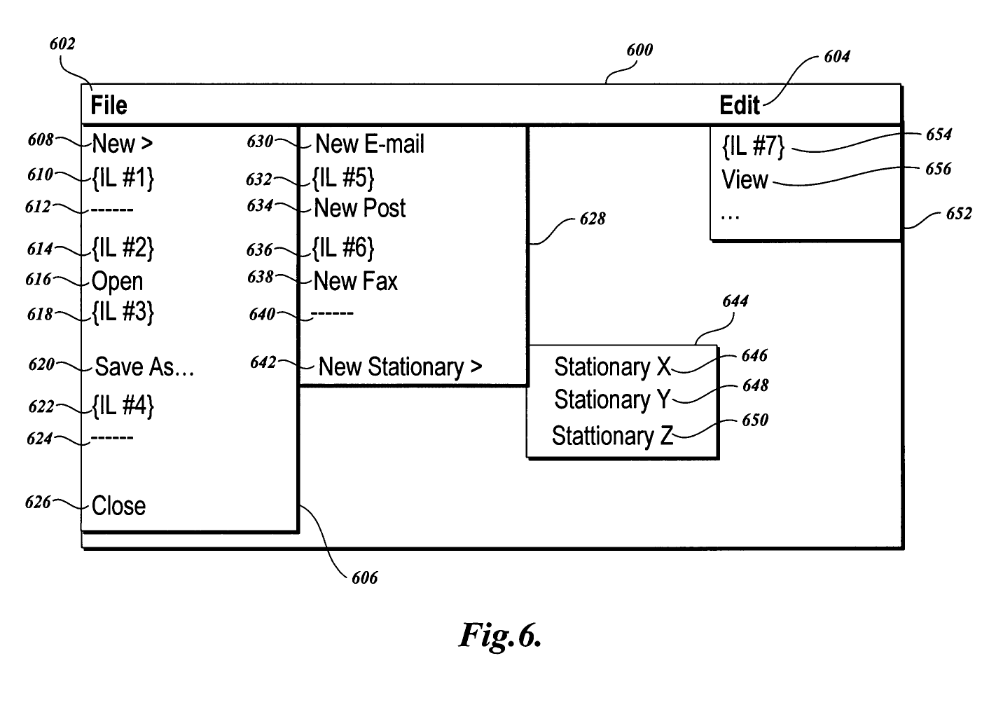

FIG. 6 is a pictorial diagram of an exemplary host UI 600 employing the present invention. The UI 600 is an instance of a UI resource 400 (FIG. 4) that comprises a layout of the various command items 402 and insert locations 420 as defined by the host 510 (FIG. 5). As shown, the UI 600 provides a layout of command items 402 and insert locations 420 into a menu and submenu type of UI. The menu bar of UI 600 contains a file menu item 602 and an edit menu item 604. The File menu item 602 expands into a vertical submenu list 606 containing four command items,-New 608, Open 614, Save As 620, and Close 626. Interspersed between the command items 402 (FIG. 4) are four insert locations 420 (FIG. 4),-IL #1 610, IL #2 614, IL #3 618, and IL #4 622. The vertical submenu list 606 includes two menu separators 612 and 624. The menu separators 612 and 624 may be represented as command items 402 (FIG. 4), each having its own UUID 406 to uniquely identify one separator from another. As shown, UI 600 indicates that the host constrains extensions from inserting any command items after the second separator 624 in the vertical submenu list 606.

The New 608 command item is a parent command item that, when selected, opens up a lower order vertical submenu list 628 that contains four child command items 402 (FIG. 4),-New E-mail 630, New Post 634, New Fax 638, and New Stationary 642. Interspersed between the child command items are two additional insert locations 420 (FIG. 4),-IL #5 632 and IL #6 636. There is one menu separator 640 appearing below the New Fax 638 menu item. As shown, UI 600 indicates that the host constrains extensions from inserting any command items after the separator 640 in the vertical submenu list 628.

The New Stationary 642 command item is a parent command item that, when selected, opens up a still lower order vertical submenu list 644 that contains three grandchild command items,-Stationary X 646, Stationary Y 648, and Stationary Z 650.

The Edit menu item 604 expands into yet another vertical submenu list 652 containing one command item, View 656, and one insert location, IL #7 654. As shown, UI 600 indicates that the host constrains extensions from inserting any command items after the View 656 command item in the vertical submenu list 606.

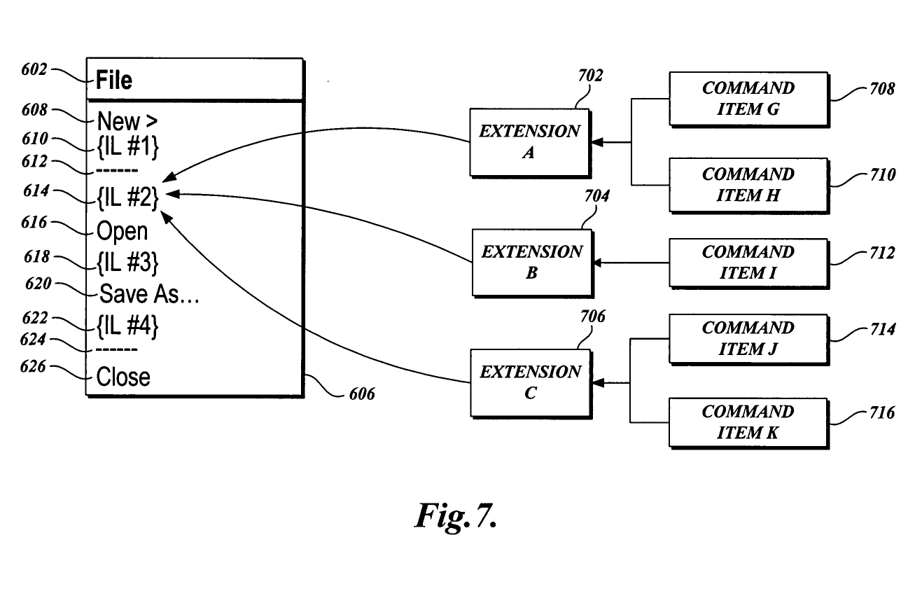

FIG. 7 is a pictorial diagram of a portion of the exemplary host UI 600 shown in FIG. 6 depicting a relation to multiple extensions and command items. Specifically, FIG. 7 illustrates the vertical submenu list 606 for the File 602 menu item, and three extensions A 702, B 704, and C 706, each of which is extending the host UI 600 by inserting command items into the location defined by IL #2 614. Extension A 702 is inserting two command items, command item G 708, and command item H 710. Extension B is inserting one command item, command item I 712. Extension C is inserting two more command items, command item J 714 and command item K 716.

In operation, the host loads the extensions and passes to each extension the UUIDs of available insert locations, in this case, IL #1 610, IL #2 614, IL #3 618, IL #4 622, IL #5 632, IL #6 636, and IL #7 654. Each extension then returns a set of command items to be inserted into one of the available locations. In this case, extension A 702 has returned a set of two command items, command item G 708 and command item H 710, to be inserted into IL #2 610. Extension B 704 has returned one command item, command item I 712 to be inserted into IL #2. Extension C 706 has returned a set of two command items, command item J 714 and command item K 716, to be inserted into IL #2 610. The host determines the load order of the extensions and concatenates the command items accordingly for insertion into the IL #2 614 insert location. The extensions cannot prioritize their command items over other extensions' command items.

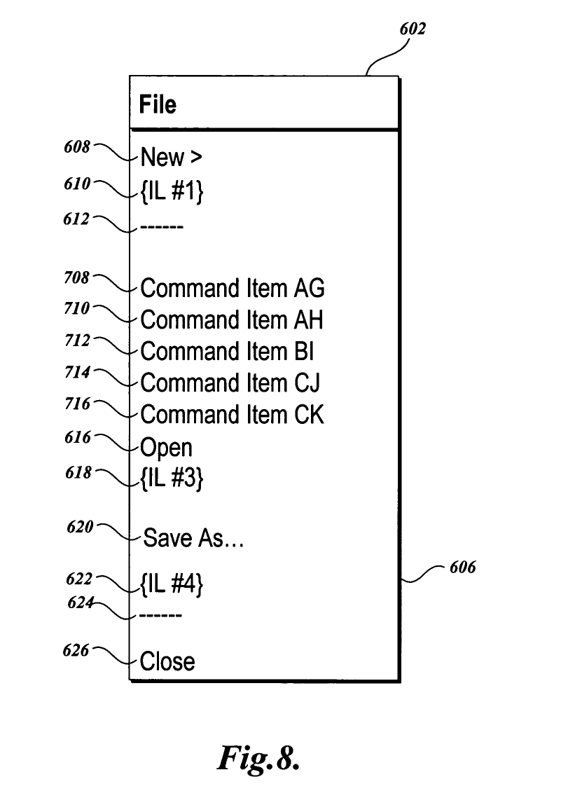

FIG. 8 is a pictorial diagram of the portion of the exemplary host UI 600 of FIG. 6 modified with multiple extensions and command items of FIG. 7. Specifically, the extended UI for the File menu item 602 and vertical submenu list 606 is illustrated in FIG. 8. Since the extension load order is A, B, and C, the host inserts the command items in that order, resulting in command item AG 708, command item AH 710, command item BI 712, command item CJ 714, and command item CK 716 inserted at insert location IL #2 614, after the separator 612 and before the Open 616 command item. Thus, the host keeps track of which extension added which command item. In a preferred embodiment, when implemented as part of an IOleCommandTarget interface, the host can instead use the command item's UUID and the Exec or Query Status methods as needed to find the appropriate extension for a selected command item. The return value of the IOleCommand Target can indicate whether the extension wants to suppress the host from handling the event. This enables the extension to intercept the host to, among other actions, cause the associated command to have no action, cause the extension to carry out an action before the host can carry out its own action, or cause the extension to carry out an action and suppress to host's action (i.e., to replace the host's action).

Referring back to FIG. 6, before an extension generates a command item 402 (FIG. 4) or set of command items 402 (FIG. 4) to be inserted in an insert location 420 (FIG. 4), the extension can itself load sub-extensions to extend its own UI. For example, the parent New Stationary 642 command item UI may have been generated from a stationary plug-in that was itself extended to include the vertical submenu list 644 of child command items Stationary X 646, Stationary Y 648, and Stationary Z 650 prior to being inserted into the host's New 608 vertical submenu list 628.

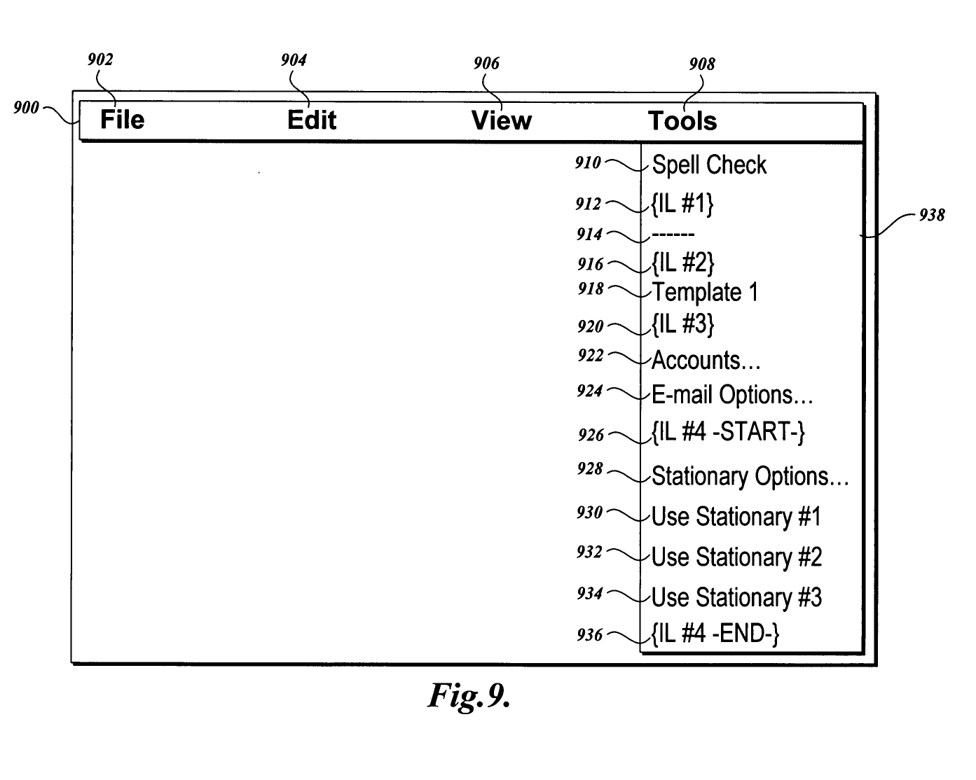

FIG. 9 is a pictorial diagram of a first version of an exemplary modified host UI 900 employing an embodiment of the present invention. As shown, the modified host UI 900 comprises four menu items in a horizontal menu bar UI, including File 902, Edit 904, View 906, and Tools 908. The Tools 908 menu item expands into a vertical submenu list 938 comprising a Spell Check 910 command item followed by two insert locations IL #1 912 and IL #2 916, that are separated by a menu separator 914. Following IL #2 is a Template 1 918 command item followed by another insert location IL #3 920, and two more command items, Accounts 922 and E-mail Options 924. The E-mail Options 924 command item UI has been extended by a stationary options plug-in that inserted in IL #4 926/936 a Stationary Options 928 command item followed by three use stationary command items, Use Stationary #1 930, Use Stationary #2 932, and Use Stationary #3.

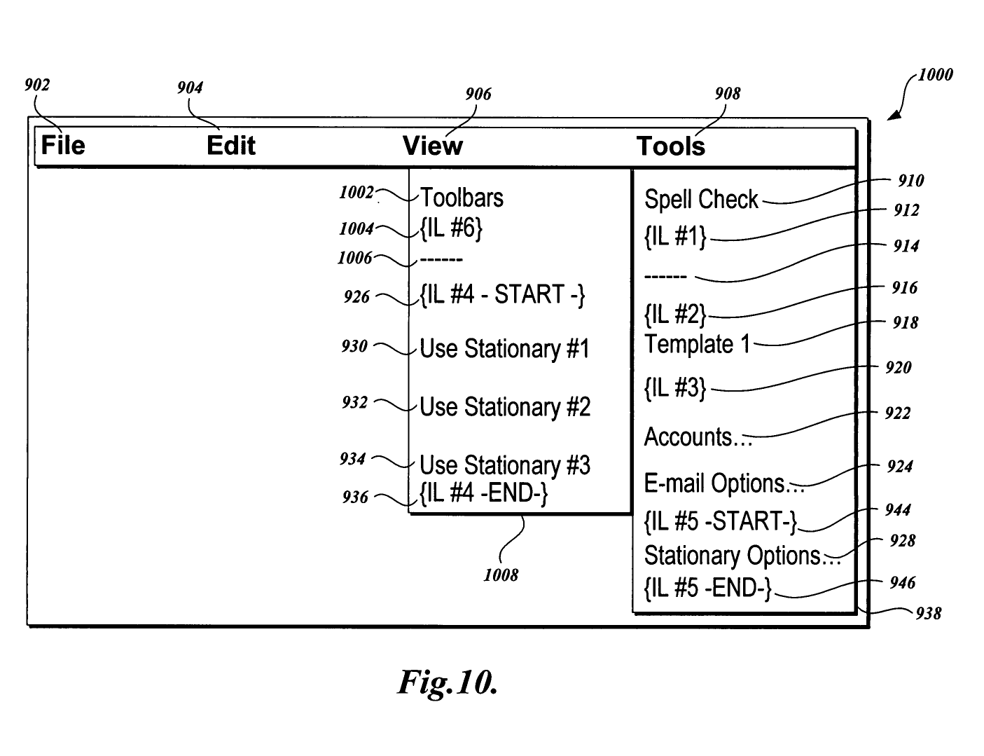

FIG. 10 is a pictorial diagram of a second version of the exemplary modified host UI of FIG. 9 employing an embodiment of the present invention. In the second version of the host UI, IL #4 has been moved from the Tools 908 submenu list 938 to the View 906 submenu list 1008. Two new insert locations have been added,-IL #5 944/946 in the Tools submenu 938 and IL #6 in the View 906 submenu 1008. As a result of moving IL #4 926/936, the stationary option command items Use Stationary #1 930, Use Stationary #2 932, and Use Stationary #3 934 have followed IL #4 to its new location in the View 906 submenu 1008. Note, however, that the Stationary Options command itself appears in the new insert location IL #5 944/946. In this example, the host implemented a special case exception for the UUID of the Stationary Options 928 command item when it was extended into IL #4 926/936, so that it was instead relocated into new insert location IL #5 944/946. As a result, the extended host UI appears to have retained the Stationary Options 928 command item in the original IL #4 location in the Tools 908 submenu 938, while relocating the use stationary command items 930, 932, and 934 into the new IL #4 location in the View 906 submenu 1008.

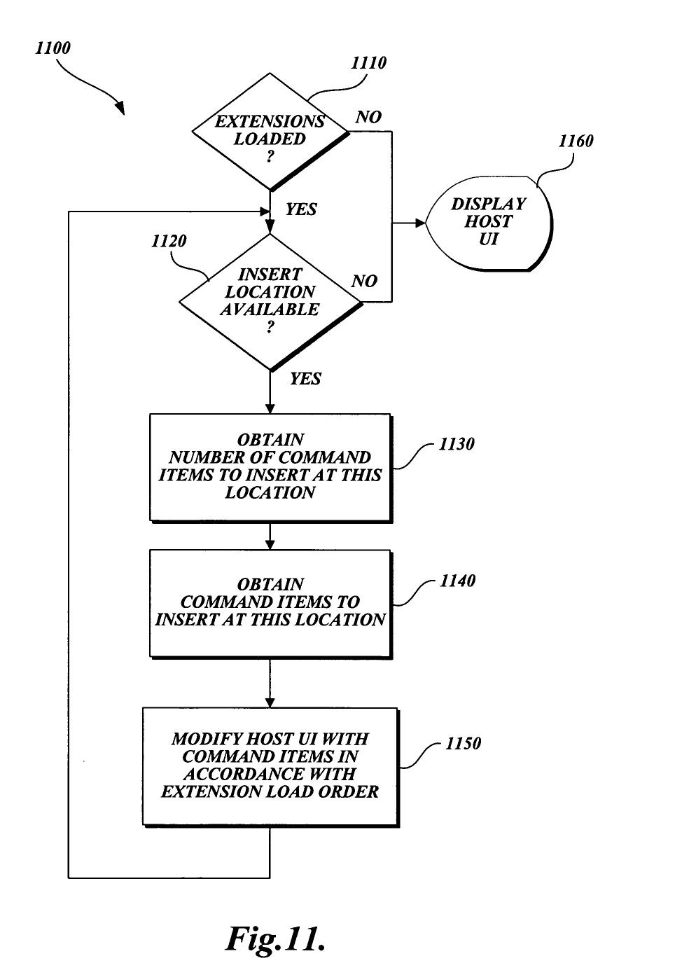

FIG. 11 is a flow diagram illustrating the logic performed by a general purpose computer system for modifying a host UI in accordance with the present invention. At decision block 1110, the host determines whether any extensions have been loaded. If not, the remainder of the interface is bypassed and the host displays the host UI without modification. Otherwise, the host continues to determine at decision block 1120 whether any insert locations are available for the extension to use. If not, the remainder of the interface is bypassed and the host displays the host UI without modification. Otherwise, the host continues at processing block 1130 to obtain the number of command items that the extensions want to insert at each of the available locations. The host continues at processing block 1140 to obtain the command items, or sets of command items, that each host wants to insert at each of the locations. After obtaining the command item and insert location information, at processing block 1150, the host modifies the host UI in accordance with the extension load order, using the obtained command item and insert location data.

While the presently preferred embodiments of the invention have been illustrated and described, it will be appreciated that various changes may be made therein without departing from the spirit and scope of the invention. For example, in other embodiments of the present invention, extensions may not extend their UIs prior to extending a host UI. In yet other embodiments, the command items of extensions written to previous versions of the host UI may not be accommodated.

1. A method for modifying a host user interface (UI), the method comprising:
storing a UI for a command in a uniquely identified command item;
obtaining from a host a uniquely identified insert location available to insert the command's stored UI into the host's UI; and
requesting the host to insert the command's stored UI into the host UI at the uniquely identified insert location.

2. The method of claim 1, wherein storing a UI for the command in a uniquely identified command item further comprises:
generating a unique universal identifier (UUID) for the command; and
storing at least one of a text, an icon, a status text, and a hotkey together with the UUID in a command item data structure.

3. The method of claim 2, wherein storing a UI for the command in a uniquely identified command item further comprises:
obtaining a related command from a sub-extension;
storing an index to the related command in the command item data structure; and
requesting the host to insert the related command's stored UI into the host UI at the uniquely identified insert location, wherein the related command's stored UI is in its own command item data structure accessible to the host via the index.

4. The method of claim 3, wherein the related command is one of a sibling of the command and a child of the command.

5. The method of claim 1, wherein obtaining from the host the uniquely identified insert location includes requesting from the host available insert locations and receiving from the host at least one UUID identifying each of the available insert locations.

6. A method for modifying a host user interface (UI), the method comprising:
loading at least one extension;
uniquely identifying for the at least one extension an available insert location where the extension may request to insert commands into a host UI;
obtaining from the at least one extension at least one uniquely identified command to insert at the available insert location; and
integrating the command in the available insert location in accordance with the extension's load order.

7. The method of claim 1, wherein the uniquely identified command specifies a UI to be used when integrating the command into the host UI.

8. The method of claim 1, wherein the specified UI includes at least one of display text, a display icon, a status display text, a help text, an accelerator key, and an index to any related commands, and wherein integrating the command in the available insert location of the host UI is performed in accordance with the specified command UI.

9. The method of claim 1, further comprising remapping the insert locations into a different portion of the host UI than in prior versions of the host UI, and integrating the command into the host UI in the remapped insert locations.

10. The method of claim 9, the method further comprising:
retaining a specified command in an a portion of the host UI associated with the original insert location even after remapping the insert location to the different portion of the host UI.

11. A method of communicating between a host and an extension, the method comprising:
an extension storing a UI for a command in a command item in preparation for communicating with a host;
a host issuing a call to the extension to return a number of command items to be inserted into an insert location;
the extension returning the number of command items to be inserted into the insert location;
the host issuing a call to an extension to return the command items to be inserted into the insert location;
the extension returning the command items to be inserted into the insert location; and
the host integrating the command for each of the returned command items into a host UI in accordance with each command item's stored UI.

12. The method of claim 11, further comprising:
the host issuing a call to the extension to return a status of the command when the integrated command has become visible in the host UI; and
the extension issuing a call to the host returning the status of the command; and
the host modifying a display of the integrated command in accordance with the returned status of the command.

13. The method of claim 12, wherein the integrated command has become visible in the host UI when the integrated command is displayed in a menu item in the host UI, and the menu item is being dropped down in response to a user action.

14. The method of claim 11, further comprising:
the host issuing a call to the extension to execute the command when the integrated command has been invoked in the host UI; and
the extension issuing a call to the host returning the result of the executed command; and
the host modifying a display of the integrated command in accordance with the returned result of the executed command.

15. A system to safely modify a host user interface (UI) with extensions, the system comprising:
a memory in which to store a command item representing a UI for a command, and an insert location available to integrate the command into a host UI;
a processing unit operable to return the command item in response to a request for commands to integrate into the host UI at the insert location; and
a display device to display the command integrated into the host UI at the insert location in accordance with command item UI.

16. The system of claim 15, wherein the processing unit is operable to integrate multiple commands into the host UI at the insert location in accordance with a priority of an extension that generated the commands.

17. The system of claim 16, wherein the processing unit is operable to determine the priority of the extension that generated the command based on an order in which the extension was loaded into the system.

18. The system of claim 17, wherein the memory in which to store the command item and insert location is to further store a universally unique identifier (UUID) for each of the command item and insert location to uniquely identify the command item and insert location from among a plurality of command items and insert locations.

19. The system of claim 17, wherein the processing unit is operable to request a command status from the extension that generated the command by the command's UUID.

20. The system of claim 17, wherein the processing unit is operable to request from the extension commands to be inserted at an insert location of a host UI by the insert location's UUID.

21. A computer-accessible medium having components for safely modifying a host user interface with an extension user interface, the medium comprising:
a user interface (UI) resource having a command item data structure in which to store a command UI, and an insert location data structure to store an available insert location in a host UI; and
a host interface to expose the available insert locations to extensions that have commands to insert into the host UI, and to receive a count of command items and command items representing the extension's commands;
an extension interface to receive the available insert locations from the host and to provide the count of command items and command items representing the extension's commands; and
a host process to integrate the extension's command into the host interface in accordance with the UI resource.

22. The computer-accessible medium of claim 21, wherein the command item data structure includes a universal unique identifier (UUID) with which to uniquely identify the command, and the command UI includes at least one of a text, a icon, a status text, and help text, each of which is used to display the command in the host UI.

23. The computer-accessible medium of claim 21, wherein the insert location data structure includes a universal unique identifier (UUID) with which to uniquely identify the insert location, wherein the insert location represents an actual location within the host UI.

24. The computer-accessible medium of claim 21, further comprising:
a declarative list having a command item data structure in which to store an extension command UI, and an insert location data structure to store an available insert location in a extension UI;
an extension interface to expose available insert locations to sub-extensions that have commands to insert into an extension UI, and to receive a count of command items and command items representing the sub-extension's commands;
a sub-extension interface to receive the available insert locations from the extension and to provide the count of command items and command items representing the sub-extension's commands; and
an extension process to integrate the sub-extension's command into the extension UI prior to providing to the host the count of command items and command items representing the extension's commands.
